(19) United States
(12) Patent Application Publication
(10) Pub. No.: US 2012/0152849 A1
(43) Pub. Date: Jun. 21, 2012

(54) ADSORPTIVE FLOTATION REMOVAL OF SODIUM TRIPOLYPHOSPHATE FROM WASTE LIQUID

(75) Inventor: Angele Sjong, Louisville, CO (US)

(73) Assignee: Empire Technology Developement LLC, Wilmington, DE (US)

(21) Appl. No.: 13/062,209

(22) PCT Filed: Dec. 20, 2010
(86) PCT No.: PCT/US10/61330

§ 371 Date: Mar. 3, 2011

(51) Int. Cl. C02F 1/24

(52) U.S. Cl. 210/703

(57) ABSTRACT

Techniques are generally described herein for the removal of sodium tripolyphosphate from a waste liquid. Embodiments include, but are not limited to, methods, apparatuses, systems, and articles of manufacture. Other embodiments may also be disclosed and claimed. Some techniques described herein include adding a phosphate binder to the waste liquid including sodium tripolyphosphate to cause the sodium tripolyphosphate to adsorb to the phosphate binder, and aerating the waste liquid to form bubbles in the waste liquid and to cause particles of the phosphate binder having the sodium tripolyphosphate adsorbed thereto to adhere to the bubbles and rise to a top surface of the waste liquid.

### BACKGROUND

Phosphates may be used as a detergent builder for chelating and removing various ions present in hard water. The removal of hard water ions may allow for a reduction in the concentration of surfactant necessary for detersive action. Phosphates, however, have been implicated in eutrophication, an increase in nutrients in water bodies (lakes, streams, and the like) sometimes resulting in excessive plant growth. As dead plant matter decomposes, dissolved oxygen may be reduced, which starves fish and other organisms.

### BRIEF DESCRIPTION OF THE DRAWINGS

Subject matter is particularly pointed out and distinctly claimed in the concluding portion of the specification. The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 is a block diagram of an example system for removing sodium tripolyphosphate from a waste liquid;

FIG. 2 is a simplified representation of an example separation cell and the sodium tripolyphosphate removal process;

FIG. 3 is a flow diagram illustrating some of the operations associated with an example method for removing sodium tripolyphosphate from a waste liquid;

FIG. 4 is a block diagram of an example computing device for facilitating removal of sodium tripolyphosphate from a waste liquid; and

FIG. 5 is a block diagram of an example computer program product for facilitating removal of sodium tripolyphosphate from a waste liquid;

all arranged in accordance with various embodiments of the present disclosure.

### DETAILED DESCRIPTION OF EMBODIMENTS

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The removal of sodium tripolyphosphate from a waste liquid is disclosed. Embodiments include, but are not limited to, methods, apparatuses, systems, and articles of manufacture. Other embodiments may also be disclosed and claimed.

Various embodiments may include adding a phosphate binder to a waste liquid including phosphates, such as, for example, waste detergent water, and aerating the liquid to cause particles of the phosphate binder having sodium tripolyphosphate adsorbed thereto to rise to a top surface of the liquid. The particles may be removed from the top surface of the waste liquid and are then available for solid-waste disposal. The effluent liquid having sodium tripolyphosphate removed therefrom may then be disposed of as standard wastewater or may be reclaimed with or without further treatment.

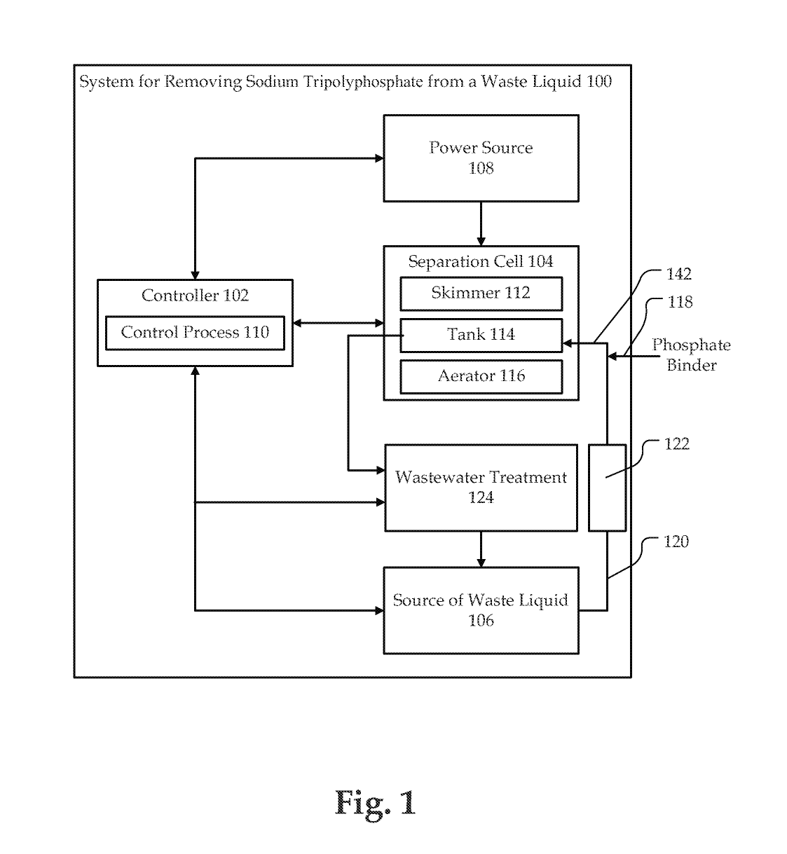

FIG. 1 is a block diagram of an example system for removing sodium tripolyphosphate from a waste liquid, arranged in accordance with at least some embodiments of the present disclosure. A basic configuration of system 100 may include a controller 102, a separation cell 104, a waste liquid source 106, and a power source 108, all coupled together and generally configured as illustrated.

Separation cell 104 may be configured to remove sodium tripolyphosphate from a waste liquid according to the various methods described herein. A phosphate binder may be provided via inlet 118 to liquid including sodium tripolyphosphate provided via inlet 120. The phosphate binder may adsorb to sodium tripolyphosphate in the waste liquid and provided to tank 114 via inlet 142 as illustrated. In various embodiments, the phosphate binder may additionally or alternatively adsorb to sodium tripolyphosphate in tank 114. A pump 122 may be configured to route the waste liquid to tank 114. The waste liquid in tank 114 may be aerated by aerator 116 to cause particles of the phosphate binder having sodium tripolyphosphate adsorbed thereto to rise to a top surface of the waste liquid in separation cell 104, as described more fully herein. A skimmer 112 may be configured to then remove the particles that rise to the top surface of the waste liquid. The removed particles of phosphate binder having sodium tripolyphosphate adsorbed thereto may then be made available for solid-waste disposal.

The waste liquid including phosphates may be received, directly or indirectly, from a source of waste liquid including sodium tripolyphosphate 106. In various embodiments, source 106 may comprise a waste liquid source (e.g., a dishwasher, a washing machine, or the like). Waste liquid may comprise, for example, waste wash water. In various instances, waste wash water may be a vastly different medium than other types of liquid such as seawater. For example, the phosphate in waste detergent water may include sodium tripolyphosphate with the chemical formula of Na₅P₃O₁₀, which may eventually be broken down (i.e., hydrolyzed) biochemically by bacteria in sewage pipes, water bodies, etc., to phosphate, PO₄³⁻. In other words, upstream of sewage, the “phosphate” may not be PO₄³⁻, but may instead be Na₅P₃O₁₀. In addition, waste wash water may contain a large amount of surfactants, which may not be present in other types of waste liquid, and/or may contain one or more components that may compete with sodium tripolyphosphate for adsorption sites on whatever phosphate binder is used.

In various embodiments, the waste liquid having sodium tripolyphosphate removed according to the embodiments described herein (“effluent liquid”) may be reclaimed for further use. Reclaimed liquid may be subjected to a wastewater treatment for removing physical, chemical, or biological contaminants prior to and/or after removal of sodium tripolyphosphate. As illustrated, for example, system 100 may include a wastewater treatment apparatus 124, and the effluent liquid may be routed from tank 114 to the wastewater treatment apparatus 124 for treatment. The reclaimed liquid may be routed to another component (e.g., source 106 or another component) within system 100 for use. Additionally or alternatively, the reclaimed liquid and/or the effluent liquid may be routed outside system 100 for disposal or further use and/or treatment.

Controller 102 may be any device suitable for monitoring, adjusting, and/or controlling a process of removing sodium tripolyphosphate from a waste liquid according to the various methods described herein. For example, controller 102 may be a computing device (e.g., a computer system, a microprocessor, a microcontroller, etc.) or an embedded controller (e.g., an Application Specific Integrated Circuit (ASIC), or some other equivalent). Controller 102 may include a control process 110 that includes one or more instructions for monitoring, adjusting, and/or controlling the process of removing sodium tripolyphosphate from a waste liquid according to the various methods described herein. As an example, control process 110 may include instructions for implementing a method for removing sodium tripolyphosphate from a waste liquid, comprising adding a phosphate binder, via inlet 118, to liquid including sodium tripolyphosphate received by tank 114 from source 106, via inlet 120, and aerating the waste liquid to cause particles of the phosphate binder having the sodium tripolyphosphate adsorbed thereto to rise to a top surface of the waste liquid in tank 114. Various instructions processed by controller 102 may include operating power source 108 to control signals (e.g., voltage, current, etc.) delivered to the separation cell 104, operating tank 114 to receive the waste liquid including the sodium tripolyphosphate, the phosphate binder, or both, and to output the effluent liquid having sodium tripolyphosphate removed therefrom, operating aerator 116 to aerate the liquid in separation cell 104, operating skimmer 112 to remove the particles from the top surface of the waste liquid in tank 114, and/or any monitoring, adjusting, and/or controlling other control(s) associated with removal of phosphates from a waste liquid in separation cell 104.

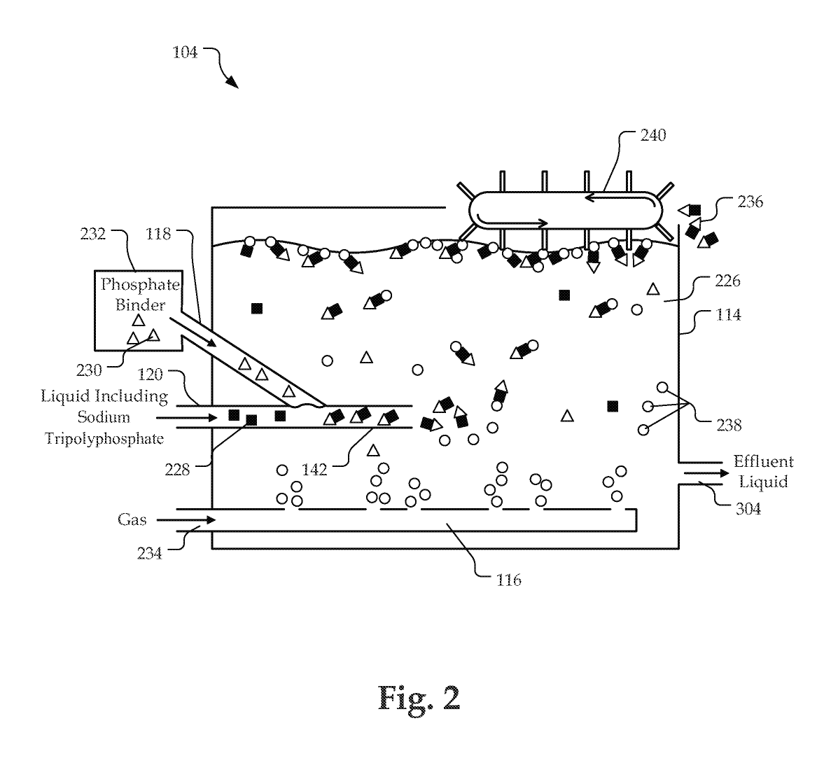

A simplified representation of an example separation cell and the sodium tripolyphosphate removal process for at least some embodiments of the present disclosure is illustrated in FIG. 2. As illustrated, waste liquid 226 including sodium tripolyphosphate 228 (depicted as solid squares) may be provided to tank 114 via an inlet 120, and a phosphate binder 230 (depicted as triangles) may be provided to the waste liquid 226 via an inlet 118. For various embodiments, phosphate binder 230 may be additionally or alternatively provided directly to tank 114 having waste liquid 226 therein. The phosphate binder 230 may be held by a hopper 232 or any suitable receptacle for holding and routing the phosphate binder 228 to waste liquid 226 and/or tank 114.

Sodium tripolyphosphate 228 may adsorb to phosphate binder 230 to form particles 236 that are insoluble in water. A suitable phosphate binder 230 may comprise a salt of at least one of magnesium, lanthanum, nickel, cadmium, iron, zinc, cobalt, strontium, barium, or manganese, and the selected phosphate binder 230 may be one being sufficiently insoluble in waste liquid 226 so as to facilitate removal of particles 236 from the top surface of the waste liquid 226. Calcium carbonate, for example, may be used as phosphate binder 230. Other suitable salts may include calcium acetate, magnesium carbonate, lanthanum carbonate, calcium acetate, magnesium carbonate, lanthanum carbonate, nickel carbonate, cadmium carbonate, iron carbonate, zinc carbonate, cobalt carbonate, strontium carbonate, barium carbonate, or manganese carbonate, or mixtures thereof.

Particles 236, comprised of phosphate binder 230 having sodium tripolyphosphate 228 adsorbed thereto, may be introduced to tank 114 via inlet 142, as illustrated, and particles 236 may be removed from waste liquid 226 by causing particles 236 to be carried to a top surface of waste liquid 226 by one or more gas bubbles 238 (depicted as circles) to form a froth. In principle, and without being bound by theory, sodium tripolyphosphate 230 adsorb to phosphate binder 230, and phosphate binder 230 in turn adheres to the surfaces of the gas bubbles 238 due at least in part to the insolubility of phosphate binder 230 in waste liquid 226. As the gas bubbles 238 float to the top surface of the waste liquid 226, phosphate binder 230 having sodium tripolyphosphate 228 adsorbed thereto are in effect carried to the top surface of waste liquid 226. Particles 236 may then be skimmed from the top surface of waste liquid 226 by a skimmer 240. Gas bubbles 238 may be formed by introducing air, nitrogen, oxygen, or another suitable gas to the waste liquid via an inlet 234, and an aerator 116 may be configured to cause the gas to be introduced to waste liquid 226 as gas bubbles 238 in waste liquid 226. Any suitable apparatus may be used for aerating waste liquid 226 including, for example, a sparger (as illustrated), an injector, an aspirator, a nozzle, a bubble generator, or the like. Particles 236 may then be skimmed from the top surface of waste liquid 226 by a skimmer 240 or other suitable method for removing particles 236 from the top surface of waste liquid 226.

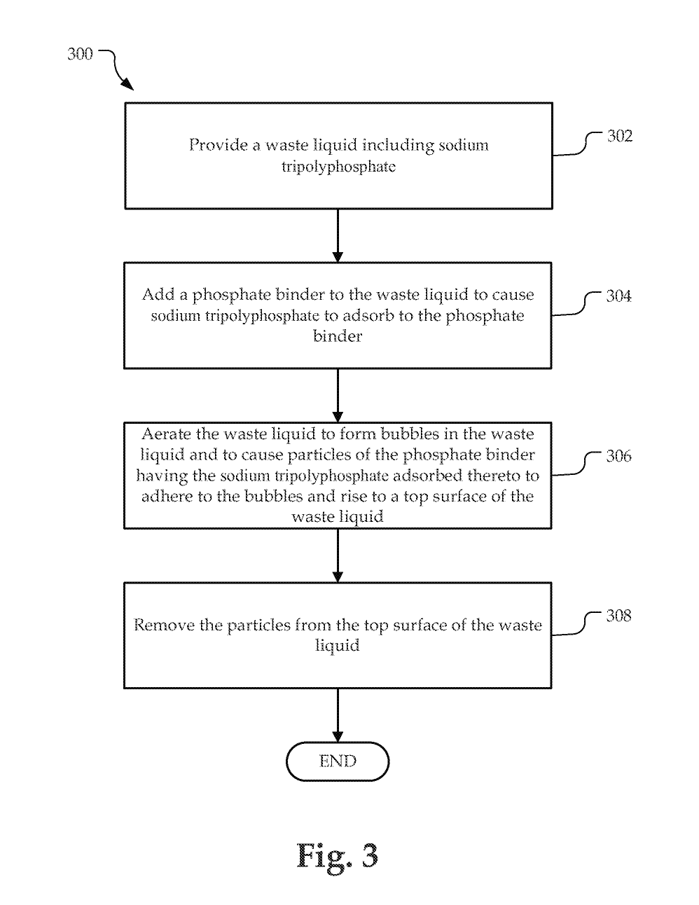

FIG. 3 is a flow diagram illustrating some of the operations associated with an example method for removing sodium tripolyphosphate from a waste liquid, arranged in accordance with at least some embodiments of the present disclosure. It should be noted that although the method is illustrated as a series of sequential steps, the method is not necessarily order dependent. Moreover, methods within the scope of this disclosure may include more or fewer steps than that illustrated.

Turning now to FIG. 3, with continued reference to system 100 illustrated in FIG. 1, method 300 may include one or more functions, operations, or actions as is illustrated by block 302, block 304, block 306, and/or block 308. Processing for method 300 may start with block 302 (“Provide a waste liquid including sodium tripolyphosphate”). The liquid including sodium tripolyphosphate may be generated by cleaning apparatus 106 of system 100, or may be provided from another source as described herein.

From block 302, method 300 may proceed to block 304 (“Add a phosphate binder to the waste liquid to cause sodium tripolyphosphate to adsorb to the phosphate binder”), and then to block 304 (“Aerate the waste liquid to form bubbles in the waste liquid and to cause particles of the phosphate binder having the sodium tripolyphosphate adsorbed thereto to adhere to the bubbles and rise to a top surface of the waste liquid”). The phosphate binder may be routed to the waste liquid by hopper 232 of separation cell 104 or by another suitable apparatus, and the waste liquid may be aerated using aerator 116 of separation cell 104 or another suitable apparatus for providing gas bubbles in the waste liquid. In some embodiments, for example, the phosphate binder may be manually added to the waste liquid. The phosphate binder may be routed to the waste liquid prior to aeration, during aeration, or both.

From block 306, method 300 may proceed to block 308 (“Remove the particles from the top surface of the waste liquid”). As described herein, the bubbles provided by the aeration may carry the particles to the top surface forming a froth that may be removed for solid-waste disposal or other use. Skimmer 240 may be suitable for removing the particles.

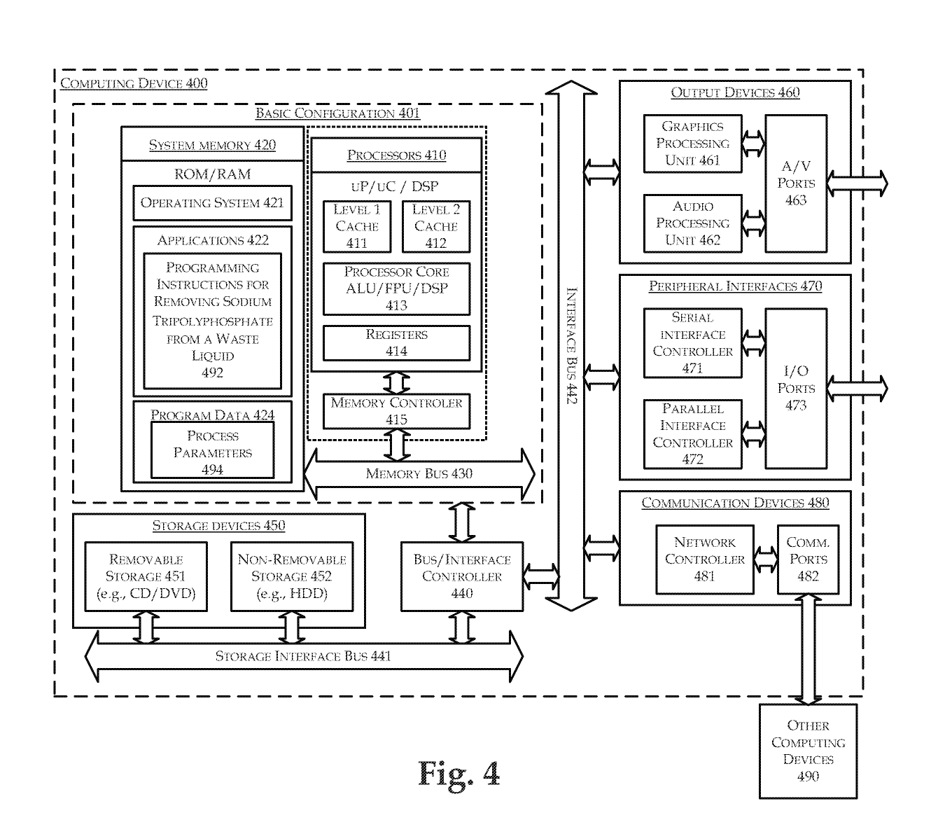

FIG. 4 is a block diagram illustrating an example computing device configured for facilitating removal of sodium tripolyphosphate from a waste liquid in accordance with at least some embodiments of the present disclosure. In a basic configuration 401, computing device 400 typically includes one or more processors 410 and system memory 420. A memory bus 430 may be used for communicating between processor 410 and system memory 420. In various embodiments, computing device 400 may be adapted to monitor, adjust, and/or control a process of removing sodium tripolyphosphate from a waste liquid as described herein. Computing device 400 may be implemented, for example, as controller 102 of system 100 of FIG. 1.

Depending on the desired configuration, processor 410 may be of any type including but not limited to a microprocessor (μP), a microcontroller (μC), a digital signal processor (DSP), or any combination thereof. Processor 410 may include one more levels of caching, such as a level one cache 411 and a level two cache 412, a processor core 413, and registers 414. An example processor core 413 may include an arithmetic logic unit (ALU), a floating point unit (FPU), a digital signal processing core (DSP Core), or any combination thereof. An example memory controller 415 may also be used with processor 410, or in some implementations memory controller 415 may be an internal part of processor 410.

Depending on the desired configuration, system memory 420 may be of any type including but not limited to volatile memory (such as RAM), non-volatile memory (such as ROM, flash memory, etc.) or any combination thereof. System memory 420 may include an operating system 421, one or more applications 422, and program data 424. Application 422 may include programming instructions providing logic 492 to implement the above described controlling, adjusting, and/or monitoring of a process of removing sodium tripolyphosphate from a waste liquid as described herein. Program data 424 may include the applicable process parameters 494 and related values.

Computing device 400 may have additional features or functionality, such as additional interfaces to facilitate communications between the basic configuration 401 and any required devices and interfaces. For example, a bus/interface controller 440 may be used to facilitate communications between the basic configuration 401 and one or more data storage devices 450 via a storage interface bus 441. Data storage devices 450 may be removable storage devices 451, non-removable storage devices 452, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 420, removable storage 451 and non-removable storage 452 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 400. Any such computer storage media may be part of device 400.

Computing device 400 may also include an interface bus 442 for facilitating communication from various interface devices (e.g., output interfaces, peripheral interfaces, and communication interfaces) to basic configuration 401 via bus/interface controller 440. Example output devices 460 include a graphics processing unit 461 and an audio processing unit 462, which may be configured to communicate to various external devices such as a display or speakers via one or more A/V ports 463. Example peripheral interfaces 470 include a serial interface controller 471 or a parallel interface controller 472, which may be configured to communicate with external devices such as input devices (e.g., keyboard, mouse, pen, voice input device, touch input device, etc.) or other peripheral devices (e.g., printer, scanner, etc.) via one or more I/O ports 473. An example communication device 480 includes a network controller 481, which may be arranged to facilitate communications with one or more other computing devices 490 over a network communication link via one or more communication ports 482.

The network communication link may be one example of communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 400 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 400 may also be implemented as a personal computer including both laptop computer and non-laptop computer configurations.

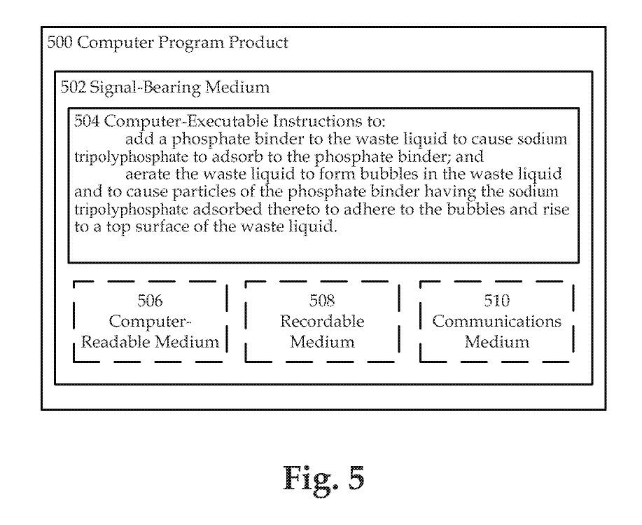

FIG. 5 is a block diagram of an example computer program product for facilitating removal of sodium tripolyphosphate from a waste liquid, arranged in accordance with at least some embodiments of the present disclosure. In an example, as shown in FIG. 5, the computer program product 500 may include a signal-bearing medium 502 that may include computer-executable instructions 504. Computer-executable instructions 504 may be for adding a phosphate binder to a waste liquid including sodium tripolyphosphate to cause sodium tripolyphosphate to adsorb to the phosphate binder. Computer-executable instructions 504 may also be for aerating the waste liquid to form bubbles in the waste liquid and to cause particles of the phosphate binder having the sodium tripolyphosphate adsorbed thereto to adhere to the bubbles and rise to a top surface of the waste liquid.

Also depicted in FIG. 5, computer program product 500 may include one or more of a computer-readable medium 506, a recordable medium 508, and a communications medium 510. The dotted boxes around these elements depict different types of mediums included within, but not limited to, a signal-bearing medium 502. These types of mediums may distribute computer-executable instructions 504 to be executed by logic. Computer-readable medium 506 and recordable medium 508 may include, but are not limited to, a flexible disk, a hard disk drive (HDD), a Compact Disc (CD), a Digital Video Disk (DVD), a digital tape, a computer memory, etc. Communications medium 510 may include, but is not limited to, a digital and/or an analog communication medium (e.g., a fiber-optic cable, a waveguide, a wired communication link, a wireless communication link, etc.).

With respect to the use of substantially any plural and/or singular terms herein, those having skill in the art may translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

Various operations may be described as multiple discrete operations in turn, in a manner that may be helpful in understanding embodiments; however, the order of description should not be construed to imply that these operations are order-dependent. Also, embodiments may have fewer operations than described. A description of multiple discrete operations should not be construed to imply that all operations are necessary. Also, embodiments may have fewer operations than described. A description of multiple discrete operations should not be construed to imply that all operations are necessary.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method for removing sodium tripolyphosphate from a waste liquid, the method comprising:
adding a phosphate binder to the waste liquid to cause the sodium tripolyphosphate to adsorb to the phosphate binder; and
aerating the waste liquid to form bubbles in the waste liquid and to cause particles of the phosphate binder having the sodium tripolyphosphate adsorbed thereto to adhere to the bubbles and rise to a top surface of the waste liquid.

2. The method of claim 1, wherein the phosphate binder comprises a carbonate.

3. The method of claim 2, wherein the phosphate binder comprises calcium carbonate.

4. The method of claim 1, wherein the phosphate binder comprises a salt of at least one of magnesium, lanthanum, nickel, cadmium, iron, zinc, cobalt, strontium, barium, or manganese.

5. The method of claim 1, wherein the phosphate binder comprises calcium acetate, magnesium carbonate, lanthanum carbonate, nickel carbonate, cadmium carbonate, iron carbonate, zinc carbonate, cobalt carbonate, strontium carbonate, barium carbonate, manganese carbonate, or mixtures thereof.

6. The method of claim 1, wherein the phosphate binder is added to the waste liquid prior to aerating the waste liquid.

7. The method of claim 1, wherein aerating the waste liquid comprises bubbling air, oxygen, or nitrogen into the waste liquid.

8. The method of claim 1, further comprising removing the particles from the top surface of the waste liquid.

9. The method of claim 1, wherein the waste liquid is waste detergent water.

10-18. (canceled)

19. A computer-readable medium having stored thereon, computer-executable instructions that, as a result of execution by an apparatus for removing sodium tripolyphosphate from a waste liquid, cause the apparatus to perform a method comprising:
adding a phosphate binder to the waste liquid including the sodium tripolyphosphate to cause the sodium tripolyphosphate to adsorb to the phosphate binder; and
aerating the waste liquid to form bubbles in the waste liquid and to cause particles of the phosphate binder having the sodium tripolyphosphate adsorbed thereto to adhere to the bubbles and rise to a top surface of the waste liquid.

20. The computer-readable medium of claim 19, wherein the instructions, in response to execution by the apparatus, further cause the apparatus to route the waste liquid to the apparatus and control the routing and the adding such that the phosphate binder is added to the waste liquid prior to aerating the waste liquid.
